(19) United States
(12) Patent Application Publication
(10) Pub. No.: US 2006/0094809 A1
(43) Pub. Date: May 4, 2006

(54) Electrically and thermally conductive silicone adhesive compositions

(76) Inventors: Davide Louis Simone, Clifton Park, NY (US); Larry Neil Lewis, Scotia, NY (US); Shahid Murtuza, Cohoes, NY (US)

Correspondence Address: GEAM - SILICONES - 60SI;IP LEGAL, ONE PLASTICS AVENUE, PITTSFIELD, MA, 01201-3697, US

(21) Appl. No.: 11/078,566

(22) Filed: Mar. 11, 2005

Related U.S. Application Data
(60) Provisional application No. 60/624,702, filed on Nov. 2, 2004.

(51) Int. Cl. C08K 3/22; B01F 17/00

(52) U.S. Cl. 524/431; 524/432; 524/433; 524/437

(57) ABSTRACT

The instant invention provides for an electrically and thermally conductive silicone adhesive composition comprising an alkenyl siloxane, a hydrido-siloxane, an electrically and thermally conductive filler, an optional thermally conductive filler, an adhesion promoter that does not deactivate the hydrosilylation catalyst, and a hydrosilylation catalyst and a hydrosilylation catalyst inhibitor.

### CROSS-REFERENCE TO RELATED APPLICATIONS

This application claims the benefit of priority from U.S. Provisional Patent Application Ser. No. 60/624,702, filed Nov. 2, 2004.

### FIELD OF THE INVENTION

The present invention relates to an electrically conductive silicone adhesive composition for use in assembly of electronic devices comprising integrated circuits.

### BACKGROUND

Semi-conductor devices, assembled from components, have a structure, for example, where a semi-conductor pellet, a component, is bonded by a conductive adhesive, such as a conductive epoxy resin or conductive polyimide resin to a tab, another component, that is the attachment site or support for the semi-conductor pellet. The semi-conductor pellet is usually connected to other devices or components by lead wires and such an assembly is frequently sealed using a sealing resin. Because such a device is composed of various materials, all of which may have differing coefficients of thermal expansion and because such devices also generate large amounts of heat when electrical current is passed through them, the differences in expansion coefficients can lead to the development of cracks in the devices.

Further these devices are frequently bonded to a ceramic, plastic, laminate, metallic, or other substrate, another component, which is in turn bonded to an electronic package such as a module card or board, another component. In many of these assemblies, solder bump connections are used to eliminate the expense, unreliability and low productivity of wire bonding the chips (a component) to their substrate (a component). This is usually accomplished by producing a mirror image of the solder bumps on the chip on the substrate. Matching of the patterns between the chip and the substrate and reflowing of the solder establishes a connection between the chip and the substrate. Once again mismatches in coefficients of thermal expansion can cause stress on delicate solder joints causing them to crack and lose effectiveness as an electrical circuit. There is also often a need to conveniently rework electrical connections with a material that will not crack or fail.

Thus flexible, electrically conductive materials are desirable in order to overcome the disadvantages associated with the differing thermal coefficients of expansion in composite electrical devices as a replacement for metallic solders.

Additionally, dispensable materials that can cure and give high thermal conductivity are of considerable use in the electronics industry. Such materials can consist of a filled matrix that is dispensed and cured in place. This dispensable approach requires that material have a viscosity that is low enough such that the material can be forced through an orifice for rapid manufacture of many parts. However, the final cured product must have a sufficiently high thermal conductivity and/or low in situ thermal resistance.

There remains a need to find a material that has a sufficiently low viscosity such that it can be rapidly placed on a small device with high power requirements. The high power device requires a way to remove large amounts of heat. This requirement necessitates a thermally conductive material. Thus, dispensable, curable, and highly thermally conductive materials are constantly being sought.

### SUMMARY OF THE INVENTION

The present invention provides for a curable thermally and electrically conductive adhesive composition, useful in the assembly and manufacture of electronic devices, comprising:

a) an alkenyl bearing siloxane having the formula:
MₐD_{b}D′_{c}T_{d}Qₑ where
M=R¹R²R³SiO_{1/2};
D=R⁴R⁵SiO_{2/2};
D′=R⁶R⁷SiO_{2/2};
T=R⁸SiO_{3/2}; and
Q=SiO_{4/2} with
   with each R¹, R², R⁴, R⁵, R⁶ and R⁸ independently selected from the group of C1 to C40 monovalent hydrocarbon radicals and each R³ and R⁷ independently selected from the group of C2 to C40 monovalent alkenyl hydrocarbon radicals, the stoichiometric coefficients a and b are non-zero and positive while the stoichiometric coefficients c, d and e are zero or positive subject to the requirement that a+c is greater than or equal to 2;

b) a hydrido-siloxane having the formula:
M′_{f}D″_{g}D″′ₕT′ᵢQ′ⱼ
   where
M′=R⁹R¹⁰R¹¹SiO_{1/2};
D″=R¹²R¹³SiO_{2/2};
D″′=R¹⁴R¹⁵SiO_{2/2};
T′=R¹⁶SiO_{3/2}; and
Q′=SiO_{4/2}
   with each R⁹, R¹⁰, R¹², R¹⁴, R⁶ and R¹⁶ independently selected from the group of C1 to C40 monovalent hydrocarbon radicals and each R¹¹ and R¹⁵ is hydrogen, the stoichiometric coefficients f and g are non-zero and positive while the stoichiometric coefficients h, i and j are zero or positive subject to the requirement that f+g is greater than or equal to 2;
c) an electrically and thermally conductive filler;
d) a hydrosilylation catalyst;
e) an adhesion promoter that does not deactivate said hydrosilylation catalyst; and a hydrosilylation catalyst inhibitor. The present invention further provides for the cured composition derived by curing the curable composition. The present invention further provides for the assembly and manufacture of electronic devices comprising a plurality (two or more) of components comprising the curable or the cured composition of the present invention.

### DETAILED DESCRIPTION OF THE INVENTION

The present invention provides for an electrically conductive silicone adhesive composition useful in the assembly of electronic devices and circuits. The conductive silicone adhesive of the present invention comprises: 1) an addition curable silicone composition; 2) an electrically and thermally conductive filler; 3) an optional thermally conductive filler; 4) an adhesion promoter that does not deactivate the addition cure catalyst; 5) hydrosilylation catalyst and 6) a hydrosilylation catalyst inhibitor.

The addition curable silicone composition, component 1), comprises a) an alkenyl bearing siloxane polymer or copolymer having on average two or more alkenyl groups per molecule and b) a hydrido-siloxane polymer or copolymer having on average two or more hydride groups per molecule. The alkenyl bearing siloxane has the formula:
MₐD_{b}D′_{c}T_{d}Qₑ
   where
M=R¹R²R³SiO_{1/2};
D=R⁴R⁵SiO_{2/2};
D′=R⁶R⁷SiO_{2/2};
T=R⁸SiO_{3/2}; and
Q=SiO_{4/2} with
   with each R¹, R², R⁴, R⁵, R⁶ and R⁸ independently selected from the group of C1 to C40 monovalent hydrocarbon radicals and each R³ and R⁷ independently selected from the group of C2 to C40 monovalent alkenyl hydrocarbon radicals, the stoichiometric coefficients a and b are non-zero and positive while the stoichiometric coefficients c, d and e are zero or positive subject to the requirement that a+c is greater than or equal to 2. The stoichiometric coefficients b and c are chosen such that the viscosity of the alkenyl bearing siloxane ranges from about 50 to 200,000 centistokes at 25° C., preferably from about 100 to 100,000 centistokes at 25° C., more preferably from about 200 to 50,000 centistokes at 25° C., and most preferably from about 275 to 30,000 centistokes at 25° C.

The hydrido-siloxane has the formula:

M′_{f}D″_{g}D″′ₕT′ᵢQ′ⱼ

where

M′=R⁹R¹⁰R¹¹SiO_{1/2};

D″=R¹²R¹³SiO_{2/2};

D″′=R¹⁴R1¹⁵SiO_{2/2};

T′=R¹⁶SiO_{3/2}; and

Q′=SiO_{4/2} with

with each R⁹, R¹⁰, R¹², R¹⁴, R⁶ and R¹⁶ independently selected from the group of C1 to C40 monovalent hydrocarbon radicals and each R¹¹ and R¹⁵ is hydrogen, the stoichiometric coefficients f and g are non-zero and positive while the stoichiometric coefficients h, i and j are zero or positive subject to the requirement that f+g is greater than or equal to 2. The stoichiometric coefficients g and h are chosen such that the viscosity of the alkenyl bearing siloxane ranges from about 1 to 200,000 centistokes at 25° C., preferably from about 5 to 10,000 centistokes at 25° C., more preferably from about 10 to 5000 centistokes at 25° C., and most preferably from about 25 to 500 centistokes at 25° C.

The amount hydrogen present as hydrido-siloxane in the total formulation ranges from about 10 to about 1000 ppm by weight of the total formulation, preferably from about 25 to about 500 ppm by weight of the total formulation, more preferably from about 50 to about 250 ppm by weight of the total formulation, and most preferably from about 80 to about 150 ppm by weight of the total formulation.

The electrically conductive filler includes metal fillers of various morphologies including fibers, spheres, flakes, and irregular geometries. The filler is an electrically conductive filler having at least an outer surface of a metal selected from the group consisting of silver, gold, platinum, palladium and alloys thereof. Fillers comprising particles consisting of silver, gold, platinum, palladium, ruthenium, osmium, rhodium, iridium and alloys thereof typically have an average particle size of from about 0.1 um to about 100 um. The core of such particles can be of any material, electrical conductor or insulator that supports a surface consisting of the aforementioned metal and does not adversely affect the electrical properties of the silicone adhesive. Examples of such materials include but are not limited to aluminum, nickel, silicon carbide, graphite, titanium diboride, aluminum oxide, boron nitride, copper, brass, solid glass, hollow glass, mica, nickel, silica, and glass fibers, ceramic oxides and ceramic fiber.

The amount of the electrically conductive filler present in the formulation ranges from about 10 to about 98 weight percent, preferably from about 50 to about 97 weight percent, more preferably from about 80 to about 95 weight percent, and most preferably from about 85 to about 93 weight percent.

The optional thermally conductive filler includes non-metal fillers of various morphologies including fibers, spheres, flakes, and irregular geometries. The filler is a thermally conductive material having an average particle size of from about 0.1 um to about 100 um. Examples of such materials include but are not limited to, aluminum oxide, aluminum nitride, boron nitride, diamond, magnesium oxide, zinc oxide, silicon oxide, and zirconium oxide. In some cases, such as silver, an electrically conductive filler can double as a thermally conductive filler.

The amount of the optional thermally conductive filler present in the formulation ranges from about 0 to about 40 weight percent, preferably from about 0.25 to about 20 weight percent, more preferably from about 0.5 to about 10 weight percent, and most preferably from about 1 to about 5 weight percent.

Adhesion promoters useful in the invention include, but are not limited to aminoalkyl silanes, methacryloxy silanes, acryloxy silanes, isocyanurates, allyl isocyanurates, fumarates, succinates, maleates, alkoxy silanes, epoxy silanes, allylic alcohols, metal alkoxides, mercaptoalkyl silanes, allyl glycidyl ethers, silyl phosphates, bis(3-trimethoxysilylpropyl) fumarate and combinations thereof. The adhesion promoter must not deactivate the hydrosilylation catalyst employed in the formulation.

The amount of the adhesion promoter present in the formulation ranges from about 0.001 to about 5 weight percent, preferably from about 0.01 to about 1 weight percent, more preferably from about 0.05 to about 0.5 weight percent, and most preferably from about 0.08 to about 0.2 weight percent.

Hydrosilylation catalysts that may be employed in the present invention include, but are not limited to catalysts comprising rhodium, platinum, palladium, nickel, rhenium, ruthenium, osmium, copper, cobalt, iron and combinations thereof. Many types of platinum catalysts for this SiH olefin addition reaction (hydrosilation or hydrosilylation) are known and such platinum catalysts may be used for the reaction in the present instance. The platinum compound can be selected from those having the formula (PtCl₂Olefin) and H(PtCl₃Olefin) as described in U.S. Pat. No. 3,159,601, hereby incorporated by reference. A further platinum containing material usable in the compositions of the present invention is the cyclopropane complex of platinum chloride described in U.S. Pat. No. 3,159,662 hereby incorporated by reference. Further the platinum containing material can be a complex formed from chloroplatinic acid with up to 2 moles per gram of platinum of a member selected from the class consisting of alcohols, ethers, aldehydes and mixtures of the above as described in U.S. Pat. No. 3,220,972 hereby incorporated by reference. The catalysts preferred for use are described in U.S. Pat. Nos. 3,715,334; 3,775,452; and 3,814,730 to Karstedt. Additional background concerning the art may be found at J. L. Spier, “Homogeneous Catalysis of Hydrosilation by Transition Metals, in Advances in Organometallic Chemistry, volume 17, pages 407 through 447, F. G. A. Stone and R. West editors, published by the Academic Press (New York, 1979). Persons skilled in the art can easily determine an effective amount of platinum catalyst. Generally, an effective amount ranges from about 0.1 to 50 parts per million of the total organopolysiloxane composition.

The amount of catalyst present in the formulation ranges from about 1 to about 1000 ppm platinum by weight of the full formulation, preferably from about 2 to about 100 ppm platinum by weight of the full formulation, more preferably from about 5 to about 50 ppm platinum by weight of the full formulation, and most preferably from about 10 to about 30 ppm platinum by weight of the full formulation.

Hydrosilylation catalyst inhibitors useful in the practice of the present invention include, but are not limited to maleates, alkynes, phosphites, alkynols, fumarates, succinates, cyanurates, isocyanurates, alkynylsilanes, vinyl-containing siloxanes and combinations thereof. Inhibitors such as esters of maleic acid (e.g. diallylmaleate, dimethylmaleate), acetylenic alcohols (e.g., 3,5 dimethyl-1-hexyn-3-ol and 2 methyl-3-butyn-2-ol), amines, and tetravinyltetramethylcyclotetrasiloxane and mixtures thereof can also be employed.

The amount of the inhibitor present in the formulation ranges from about 0.001 to about 1 weight percent, preferably from about 0.01 to about 0.6 weight percent, more preferably from about 0.05 to about 0.4 weight percent, and most preferably from about 0.08 to about 0.2 weight percent.

The adhesive compositions of the present invention will form or possess electrical and thermal paths between the components being joined by the adhesive composition. Preferred embodiments of these compositions will have useful physical and electrical properties in the following ranges.

The volume resistivity of the cured compositions of the present invention ranges from about 0.001 to about 10 milliohm·cm, preferably from about 0.002 to about 1 milliohm·cm, more preferably from about 0.005 to about 0.5 milliohm·cm, and most preferably from about 0.01 to about 0.3 milliohm·cm.

Bulk thermal conductivity ranges from about 0.2 to about 100 W/m·K, preferably from about 0.3 to about 50 W/m·K, more preferably from about 0.4 to about 35 W/m·K, and most preferably from about 0.5 to about 25 W/m·K.

The in-situ thermal resistance ranges from about 0.1 to about 300 mm²·K/W, preferably from about 0.2 to about 200 mm²·K/W, more preferably from about 0.5 to about 150 mm²·K/W, and most preferably from about 1 to about 130 mm²·K/W.

Die shear adhesion ranges from about 50 to about 1000 psi, preferably from about 100 to about 900 psi, more preferably from about 200 to about 800 psi, and most preferably from about 350 to about 700 psi.

Electrical contact resistance ranges from about 0.0001 to about 2 ohms, preferably from about 0.001 to about 1.5 ohms, more preferably from about 0.005 to about 1.0 ohms, and most preferably from about 0.01 to about 0.5 ohms.

Formulation viscosity ranges from about 2.5 to about 100 Pa·sec, preferably from about 5 to about 500 Pa·sec, more preferably from about 7.5 to about 200 Pa·sec, and most preferably from about 9 to about 175 Pa·sec.

Experimental

Small scale compounding of formulations were prepared in a Hauschild mixer in three cycles of 15 seconds at 2750 rpm with a short hand mix after each cycle. The first cycle consisted of the addition of the vinyl containing silicone polymer and the conductive filler. The additive (if applicable), adhesion promoter, catalyst, inhibitor, and silicone hydride, silica fillers were added separately with hand mixes between each addition. More specifically, the inhibitor consists of diallyl maleate; the adhesion promoter consists of (bis(trimethoxypropyl)) fumarate; the catalyst is known as Ashby's catalyst, a cyclic vinyl siloxane tetramer coordinated to platinum atoms.

Large scale compounding of formulations was conducted in a planetary mixer. The vinyl-containing silicone polymer was charged to a mix can, followed by the conductive filler and the additive (if applicable). The mixture was mixed with a spatula until all of the filler was wet by the polymer. The mixer was then started, and a vacuum of −27″ Hg was slowly applied. The compound mixed for 2 hours at ambient temperature. The mixer was then opened and the adhesion promoter added, and the compound was mixed for 30 min at ambient temperature and pressure. The catalyst was then added. After 15 min of mixing at ambient temperature and pressure, the inhibitor was added and the compound mixed for 30 min at ambient temperature and pressure. The silicone hydride was then added, and the compound was mixed for 30 min at ambient temperature under a vacuum of −27″ Hg.

All materials were cured at 150° C. for 1 hour. Viscosity was measured for examples 1 through 7, on a cone and plate viscometer (Brookfield DV-II@25° C.) at speeds where torque readings are above 40%. Viscosity was measured by controlled strain rheometer for examples 8 through 25, at a shear rate of 10 sec⁻¹ between a flat steel plate and a rotating 2 cm 1 degree steel cone. Physical properties were measured on a tensometer. Samples were die-cut from press cured sheets. Bulk thermal conductivity was calculated from in situ measurements by the laser flash method on a three-layer sample of adhesive cured at 10 psi pressure between 8 mm square coupons and as a single layer, 8 mm square cured solid. Thermal resistance was measured in situ by the laser flash method on a three-layer sample of adhesive cured at 10 psi pressure between 8 mm square coupons. In two examples an extra 10 psi pressure was added to determine the effect of compression on thermal resistance (vide infra). The coupons were silicon and silicon, silicon and chromate-coated aluminum or silicon and nickel-coated copper (specified in the tables below). Bond line thicknesses for these measurements are also specified in the tables. Die shear adhesion samples were cured at ambient pressure between a 4 mm silicon die and nickel coated copper substrate. Bulk DC resistivity of samples was measured according to ASTM D2739-97 with 10 mA applied current and by curing printed strips of conductive adhesive and measuring the resistance via a four point method. Contact resistance measurements were performed by curing a chip resistor element onto a printed circuit board with gold pads. The contact resistance was then measured via a two point test probe station and an automatic data acquisition system.

The formulation electrical resistivity after cure varied as a function of filler loading % and filler morphology. The resistivities measured ranged from 0.084 to 0.257 milliohm-cm. The largest bulk thermal conductivity measured for the samples was 16 W/m·K. In situ thermal conductivities ranged from 0.66 up to 4.2 W/m·K. The in situ thermal resistance were measured as high as 121.54 mm²·K/W to as low as 9 mm²·K/W. Die shear adhesion data indicates a distribution of adhesive strengths from as low as 206 psi to as high as 558 psi. The formulations were highly flowable with viscosities as low as 9.873 to as high as 84 Pa·sec.

### EXAMPLE 1

Hauschild mixer was used.

| Component-Type | Grams |
|---|---|
| Vinyl polymer-M^{vi}D₁₅₀M^{vi} | 8.193 |
| Silver filler-Ames Goldsmith AG4300 | 73.3 |
| Adhesion promoter- | 0.099 |
| Bis(trimethoxysilylpropyl fumarate) | |
| Catalyst-1.75% solution of Pt(0) in D^{vi}₄ | 0.108 |
| Inhibitor-General Electric SL6040-D1 | 0.139 |
| Silicone hydride-MD₅₀D^{H}₅₀M | 1.453 |

| Property (units) | Measurement |
|---|---|
| Viscosity (Pa · sec) | 10.6 ± 0.7 |
| In-situ thermal resistance@25° C., Si/CuNi | 16 ± 1 |
| (mm² · K/W) | |
| In-situ thermal resistance@125° C., Si/CuNi | 24 ± 1 |
| (mm² · K/W) | |
| In-situ thermal resistance@25° C. after 500 | 16 ± 2 |
| AATS(−55 C. to 125 C.) 10 psi assembly, no | |
| cure pressure | |
| In-situ thermal resistance@125° C. after 500 | 21 ± 2 |
| AATS (−55 C. to 125 C.) 10 psi assembly, | |
| no cure pressure (mm²-K/W) | |
| In-situ thermal resistance@25° C., Si/Al | 16.99-18.59 |
| (mm²-K/W) | |
| Die shear adhesion (psi) (Si/CuNi) | 366 ± 87 |
| Bulk thermal conductivity, Si/CuNi | 12 |
| (W/mK) | |
| In-situ bulk thermal conductivity, Si/Al | 0.75-1.38 |
| (W/mK) | |
| Electrical resistivity (milliohm-cm) | 0.233 ± 0.02 |
| Contact resistance (ohms) (Au pad) low | 0.028 ± 0.005 |
| volatile inputs | |

### EXAMPLE 2

Hauschild mixer was used.

| Component-Type | Grams |
|---|---|
| Low volatile Vinyl polymer-M^{vi}D₂₅₀M^{vi} | 14.94 |
| Silver filler-Ames Goldsmith AG4300 | 125 |
| Adhesion promoter-Bis(trimethoxysilylpropyl fumarate) | 0.169 |
| Catalyst-1.75% solution of Pt(0) in D^{vi}₄ | 0.183 |
| Inhibitor-General Electric SL6040-D1 | 0.255 |
| Low volatile Silicone hydride-MD₅₀D^{H}₅₀M | 1.45 |

| Property (units) | Measurement |
|---|---|
| Viscosity (Pa · sec) @ 10 rpm | 22.0 |
| Contact resistance (ohms) (Au pad) | 0.03 ± 0.008 |
| Bulk resistivity (milliohm-cm) | 0.216 ± 0.016 |
| In-situ bulk thermal conductivity, Si/CuNi (W/mK) | 1.12-1.45 |
| In-situ bulk thermal conductivity, Si/Al (W/mK) | 0.95-1.08 |
| In-situ thermal resistance@25° C., Si/CuNi (mm² K/W) | 35.66-50.66 |
| In-situ thermal resistance@25° C., Si/Al (mm² K/W) | 25.46-30.46 |

### EXAMPLE 3

Planetary mixer was used.

| Component-Type | Grams |
|---|---|
| Low volatile Vinyl polymer-M^{vi}D₄₂₀M^{vi} | 29.88 |
| Silver filler-Ames Goldsmith AG4300 | 238 |
| Adhesion promoter-Bis(trimethoxysilylpropyl fumarate) | 0.318 |
| Catalyst-1.75% solution of Pt(0) in D^{vi}₄ | 0.35 |
| Inhibitor-General Electric SL6040-D1 | 0.487 |
| Low volatile Silicone hydride-MD₅₀D^{H}₅₀M | 1.45 |

| Property (units) | Measurement |
|---|---|
| Viscosity (Pa · sec) @ 2.5 rpm | 84.0 |
| Contact resistance (ohms) (Au pad) stripped | 0.11 ± 0.11 |
| Contact resistance (ohms) (Au pad) | 0.14 ± 0.1 |
| Bulk resistivity (milliohm-cm) stripped | 0.245 ± 0.012 |
| In-situ bulk thermal conductivity, Si/CuNi (W/mK) | 0.82-0.89 |
| In-situ bulk thermal conductivity, Si/CuNi (W/mK) | 0.7-1.27 |
| stripped | |
| In-situ bulk thermal conductivity, Si/Al (W/mK) | 0.66-1.15 |
| In-situ Thermal Resistance@25° C., Si/CuNi (mm² K/W) | 87.07-119.54 |
| In-situ Thermal Resistance@25° C., Si/CuNi (mm² K/W) | 73.6-105.69 |
| stripped | |
| In-situ Thermal Resistance@25° C., Si/Al (mm² K/W) | 50.38-96.07 |

### EXAMPLE 4

Hauschild mixer was used.

| Component Type | Grams |
|---|---|
| Low volatile Vinyl polymer-M^{vi}D₂₅₀M^{vi} | 14.94 |
| Silver filler-Ames Goldsmith AG4300 | 153 |
| Adhesion promoter-Bis(trimethoxysilylpropyl fumarate) | 0.169 |
| Catalyst-1.75% solution of Pt(0) in D^{vi}₄ | 0.183 |
| Inhibitor-General Electric SL6040-D1 | 0.255 |
| Low volatile Silicone hydride-MD₅₀D^{H}₅₀M | 1.45 |

| Property (units) | Measurement |
|---|---|
| Viscosity (Pa · sec) @ 10 rpm | 41.0 |
| Contact resistance (ohms) (Au pad) | 0.028 ± 0.007 |
| Bulk resistivity (milliohm-cm) | 0.096 ± 0.012 |
| In-situ bulk thermal conductivity, Si/CuNi (W/mK) | 1.45-1.77 |
| In-situ bulk thermal conductivity, Si/Al (W/mK) | 1.38-1.54 |
| In-situ Thermal Resistance@25° C., Si/CuNi (mm² K/W) | 35.42-55.63 |
| In-situ Thermal Resistance@25° C., Si/Al (mm² K/W) | 24.77-34.24 |

### EXAMPLE 5

Planetary mixer was used.

| Component-Type | Grams |
|---|---|
| Low volatile Vinyl polymer-M^{vi}D₄₂₀M^{vi} | 29.88 |
| Silver filler-Ames Goldsmith AG4300 | 292 |
| Adhesion promoter-Bis(trimethoxysilylpropyl fumarate) | 0.318 |
| Catalyst-1.75% solution of Pt(0) in D^{vi}₄ | 0.35 |
| Inhibitor-General Electric SL6040-D1 | 0.487 |
| Low volatile Silicone hydride-MD₅₀D^{H}₅₀M | 1.45 |

| Property (units) | Measurement |
|---|---|
| Viscosity (Pa · sec) @ 2.5 rpm | 126.0 |
| Contact resistance (ohms) (Au pad) | 0.123 ± 0.05 |
| Bulk resistivity (milliohm-cm) | 0.097 ± 0.04 |
| In-situ bulk thermal conductivity, Si/CuNi (W/mK) | 0.8-1.09 |
| In-situ bulk thermal conductivity, Si/CuNi (W/mK) | 0.7-1.27 |
| stripped | |
| In-situ bulk thermal conductivity, Si/Al (W/mK) | 0.75-0.94 |
| In-situ Thermal Resistance@25° C., Si/CuNi (mm² K/W) | 81.47-121.54 |
| In-situ Thermal Resistance@25° C., Si/CuNi (mm² K/W) | 83.80-105.48 |
| stripped | |
| In-situ Thermal Resistance@25 C, Si/Al (mm² K/W) | 57.75-74.76 |

### EXAMPLE 6

Hauschild mixer was used.

| Component-Type | Grams |
|---|---|
| Vinyl polymer-M^{vi}D₁₅₀M^{vi} | 8.193 |
| Silver filler-Ames Goldsmith AG4300 | 90 |
| Adhesion promoter-Bis(trimethoxysilylpropyl fumarate) | 0.099 |
| Catalyst-1.75% solution of Pt(0) in D^{vi}₄ | 0.106 |
| Inhibitor-General Electric SL6040-D1 | 0.149 |
| Silicone hydride-MD₅₀D^{H}₅₀M | 1.453 |

| Property (units) | Measurement |
|---|---|
| Viscosity (Pa · sec) | 3.89 ± 2 |
| In-situ thermal resistance@25° C., Si/CuNi (mm² · K/W) | 16 ± 1 |
| In-situ thermal resistance@125° C., Si/CuNi | 25 ± 2 |
| (mm² · K/W) | |
| In-situ thermal resistance@25° C. after 500 AATS | 23 ± 2 |
| Si/CuNi (mm² · K/W) (−55 C. to 125 C.), 10 psi | |
| assembly, no cure pressure | |
| In-situ thermal resistance@125° C. after 500 AATS | 28 ± 2 |
| Si/CuNi (mm² · K/W) (−55 to 125 C.), 10 psi | |
| assembly, no cure pressure | |
| In-situ thermal resistance@25° C. Si/CuNi | 9 |
| (mm² · K/W), 10 psi assembly, 10 psi cure | |
| pressure | |
| In-situ thermal resistance@25° C. after 500 AATS | 13 |
| Si/CuNi (mm² · K/W) (−55 C. to 125 C.), 10 psi | |
| assembly, 10 psi cure pressure | |
| Die shear adhesion (psi), Si/CuNi | 239 ± 33 |
| Bulk thermal conductivity (W/mK), Si/CuNi | 16 |
| Electrical resistivity (milliohm-cm) | 0.167 ± 0.017 |
| Contact resistance (ohms) (Au pad) stripped | 0.058 ± 0.03 |
| In-situ thermal resistance@25° C., Si/Al (mm² · K/W) | 19.46-32.42 |
| In-situ bulk thermal conductivity (W/mK), Si/Al | 6.08-7.46 |

### EXAMPLE 7

Hauschild mixer was used.

| Component-Type | Grams |
|---|---|
| Low volatile Vinyl polymer-M^{vi}D₁₅₀M^{vi} | 8.19 |
| Silver filler-Ames Goldsmith AG4300 | 36.65 |
| Silver filler-Ames Goldsmith LCP1-19SFS | 36.65 |
| Adhesion promoter-Bis(trimethoxysilylpropyl fumarate) | 0.099 |
| Catalyst-1.75% solution of Pt(0) in D^{vi}₄ | 0.108 |
| Inhibitor-General Electric SL6040-D1 | 0.139 |
| Low volatile Silicone hydride-MD₅₀D^{H}₅₀M | 1.45 |

| Property (units) | Measurement |
|---|---|
| Electrical Resistivity (milliohm-cm) | 0.19 ± 0.09 |
| Contact resistance (ohms) (Au pad) | 0.032 ± 0.005 |
| In-situ bulk thermal conductivity, Si/CuNi (W/mK) | 1.57-2.42 |
| In-situ bulk thermal conductivity, Si/Al (W/mK) | 0.98-1.24 |
| In-situ Thermal Resistance@25° C., Si/CuNi (mm² K/W) | 22.23-34.86 |
| In-situ Thermal Resistance@25° C., Si/Al (mm² K/W) | 19.37-23.51 |

### EXAMPLE 8

Planetary mixer was used.

| Component-Type | Grams |
|---|---|
| Vinyl polymer-M^{vi}D₁₅₀M^{vi} | 90.48 |
| Silver filler-Ames Goldsmith AG4300 | 809.56 |
| Adhesion promoter-Bis(trimethoxysilylpropyl fumarate) | 1.094 |
| Catalyst-1.75% solution of Pt(0) in D^{vi}₄ | 1.171 |
| Inhibitor-General Electric SL6040-D1 | 1.649 |
| Silicone hydride-MD₅₀D^{H}₅₀M | 16.05 |

| Property (units) | Measurement |
|---|---|
| Viscosity (Pa · sec) | 12.56 |
| In-situ thermal resistance, Si/Cu (mm² · K/W) | 28.41 |
| Bond line thickness, Si/Cu (mils) | 1.35 |
| Die shear adhesion (psi) | 427.3 |
| Die shear adhesion after MSL Level 1 aging (psi) | 481.9 |

### EXAMPLE 9

Planetary mixer was used.

| Component-Type | Grams |
|---|---|
| Vinyl polymer-M^{vi}D₁₅₀M^{vi} | 90.48 |
| Silver filler-Ames Goldsmith AG4315C | 809.56 |
| Adhesion promoter-Bis(trimethoxysilylpropyl fumarate) | 1.094 |
| Catalyst-1.75% solution of Pt(0) in D^{vi}₄ | 1.171 |
| Inhibitor-General Electric SL6040-D1 | 1.649 |
| Silicone hydride-MD₅₀D^{H}₅₀M | 16.05 |

| Property (units) | Measurement |
|---|---|
| Viscosity (Pa · sec) | 22.80 |
| In-situ thermal resistance, Si/Cu (mm² · K/W) | 89.52 |
| Bond line thickness (mils) | 1.77 |

### EXAMPLE 10

Planetary mixer was used.

| Component-Type | Grams |
|---|---|
| Vinyl polymer-M^{vi}D₁₅₀M^{vi} | 90.03 |
| Silver filler A-Ames Goldsmith AG4300 | 805.53 |
| Silver filler B-Energy Strategy Assocs. Ag-200-CM | 4.58 |
| Adhesion promoter-Bis(trimethoxysilylpropyl fumarate) | 1.088 |
| Catalyst-1.75% solution of Pt(0) in D^{vi}₄ | 1.165 |
| Inhibitor-General Electric SL6040-D1 | 1.641 |
| Silicone hydride-MD₅₀D^{H}₅₀M | 15.97 |

| Property (units) | Measurement |
|---|---|
| Viscosity (Pa · sec) | 18.28 |
| Youngs modulus (psi) | 8276 |
| In-situ thermal resistance, Si/Cu (mm² · K/W) | 27.85 |
| Bond line thickness, Si/Cu (mils) | 1.51 |
| In-situ thermal resistance, Si/Si (mm² · K/W) | 24.42 |
| Bond line thickness, Si/Si (mils) | 3.7 |
| Die shear adhesion (psi) | 430.8 |

### EXAMPLE 11

Planetary mixer was used.

| Component - Type | Grams |
|---|---|
| Vinyl polymer - M^{vi}D₁₅₀M^{vi} | 90.03 |
| Silver filler A - Ames Goldsmith AG4300 | 805.53 |
| Silver filler B - Energy Strategy Assocs. Ag Fiber (Short) | 4.58 |
| Adhesion promoter - Bis(trimethoxysilylpropyl fumarate) | 1.088 |
| Catalyst - 1.75% solution of Pt(0) in D^{vi}₄ | 1.165 |
| Inhibitor - General Electric SL6040-D1 | 1.641 |
| Silicone hydride - MD₅₀D^{H}₅₀M | 15.97 |

| Property (units) | Measurement |
|---|---|
| Viscosity (Pa · sec) | 17.55 |
| Elongation at break (%) | 21 |
| Youngs modulus (psi) | 14146 |
| In-situ thermal resistance, Si/Cu (mm² · K/W) | 40.51 |
| Bond line thickness, Si/Cu (mils) | 2.55 |
| In-situ thermal resistance, Si/Si (mm² · K/W) | 36.74 |
| Bond line thickness, Si/Si (mils) | 2.77 |
| Die shear adhesion (psi) | 398.6 |

### EXAMPLE 12

Planetary mixer was used.

| Component - Type | Grams |
|---|---|
| Vinyl polymer - M^{vi}D₁₅₀M^{vi} | 63.71 |
| Silver filler - Ames Goldsmith AG4300 | 808.2 |
| Adhesion promoter - Bis(trimethoxysilylpropyl fumarate) | 0.770 |
| Catalyst - 1.75% solution of Pt(0) in D^{vi}₄ | 1.174 |
| Inhibitor - General Electric SL6040-D1 | 1.649 |
| Silicone hydride - MD₁₇D^{H}₄M | 44.48 |

| Property (units) | Measurement |
|---|---|
| Viscosity (Pa · sec) | 9.873 |
| Young's modulus (psi) | 4200 |
| In-situ thermal resistance, Si/Cu (mm² · K/W) | 18.33 |
| Bond line thickness, Si/Cu (mils) | 1.06 |
| In-situ thermal resistance, Si/Si (mm² · K/W) | 15.08 |
| Bond line thickness, Si/Si (mils) | 1.50 |
| Die shear adhesion (psi) | 127.5 |

### EXAMPLE 13

Planetary mixer was used.

| Component - Type | Grams |
|---|---|
| Vinyl polymer - M^{vi}D₁₅₀M^{vi} | 90.48 |
| Silver filler A - Ames Goldsmith AG4300 | 404.78 |
| Silver filler B - Ames Goldsmith LCP-1-19SFS | 404.78 |
| Adhesion promoter - Bis(trimethoxysilylpropyl fumarate) | 1.094 |
| Catalyst - 1.75% solution of Pt(0) in D^{vi}₄ | 1.171 |
| Inhibitor - General Electric SL6040-D1 | 1.649 |
| Silicone hydride - MD₅₀D^{H}₅₀M | 16.05 |

| Property (units) | Measurement |
|---|---|
| Viscosity (Pa · sec) | 16.50 |
| Elongation at break (%) | 35 |
| Youngs modulus (psi) | 11725 |
| In-situ thermal resistance, Si/Cu (mm² · K/W) | 19.15 |
| Bond line thickness, Si/Cu (mils) | 1.85 |
| In-situ thermal resistance, Si/Si (mm² · K/W) | 12.68 |
| Bond line thickness, Si/Si (mils) | 2.70 |
| Die shear adhesion (psi) | 558.2 |

### EXAMPLE 14

Planetary mixer was used.

| Component - Type | Grams |
|---|---|
| Vinyl polymer - M^{vi}D₂₅₀M^{vi} | 91.76 |
| Silver filler - Ames Goldsmith AG4300 | 809.73 |
| Adhesion promoter - Bis(trimethoxysilylpropyl fumarate) | 1.098 |
| Catalyst - 1.75% solution of Pt(0) in D^{vi}₄ | 1.170 |
| Inhibitor - General Electric SL6040-D1 | 1.649 |
| Silicone hydride - MD₅₀D^{H}₅₀M | 14.59T |

| Property (units) | Measurement |
|---|---|
| Viscosity (Pa · sec) | 20.45 |
| Elongation at break (%) | 22 |
| Youngs modulus (psi) | 16967 |
| In-situ thermal resistance, Si/Cu (mm² · K/W) | 20.62 |
| Bond line thickness, Si/Cu (mils) | 1.47 |
| In-situ thermal resistance, Si/Si (mm² · K/W) | 15.30 |
| Bond line thickness, Si/Si (mils) | 3.27 |
| Die shear adhesion (psi) | 483.5 |

### EXAMPLE 15

Planetary mixer was used.

| Component - Type | Grams |
|---|---|
| Vinyl polymer - M^{vi}D₁₅₀M^{vi} | 90.48 |
| Silver filler A - Ames Goldsmith AG4300 | 607.17 |
| Silver filler B - Ames Goldsmith LCP-1-19SFS | 202.39 |
| Adhesion promoter - Bis(trimethoxysilylpropyl fumarate) | 1.094 |
| Catalyst - 1.75% solution of Pt(0) in D^{vi}₄ | 1.171 |
| Inhibitor - General Electric SL6040-D1 | 1.649 |
| Silicone hydride - MD₅₀D^{H}₅₀M | 16.05 |

| Property (units) | Measurement |
|---|---|
| Viscosity (Pa · sec) | 11.12 |
| In-situ thermal resistance, Si/Al (mm² · K/W) | 24.25 |
| Bond line thickness (mils) | 2.06 |

### EXAMPLE 16

Planetary mixer was used.

| Component - Type | Grams |
|---|---|
| Vinyl polymer - M^{vi}D₁₅₀M^{vi} | 90.48 |
| Silver filler A - Ames Goldsmith AG4300 | 202.39 |
| Silver filler B - Ames Goldsmith LCP-1-19SFS | 607.17 |
| Adhesion promoter - Bis(trimethoxysilylpropyl fumarate) | 1.094 |
| Catalyst - 1.75% solution of Pt(0) in D^{vi}₄ | 1.171 |
| Inhibitor - General Electric SL6040-D1 | 1.649 |
| Silicone hydride - MD₅₀D^{H}₅₀M | 16.05 |

| Property (units) | Measurement |
|---|---|
| Viscosity (Pa · sec) | 23.05 |
| In-situ thermal resistance, Si/Al (mm² · K/W) | 25.28 |
| Bond line thickness, (mils) | 2.29 |

### EXAMPLE 17

Planetary mixer was used.

| Component - Type | Grams |
|---|---|
| Vinyl polymer - M^{vi}D₁₅₀M^{vi} | 90.48 |
| Silver filler - Ames Goldsmith LCP-1-19SFS | 809.58 |
| Adhesion promoter - Bis(trimethoxysilylpropyl fumarate) | 1.094 |
| Catalyst - 1.75% solution of Pt(0) in D^{vi}₄ | 1.171 |
| Inhibitor - General Electric SL6040-D1 | 1.649 |
| Silicone hydride - MD₅₀D^{H}₅₀M | 16.05 |

| Property (units) | Measurement |
|---|---|
| Viscosity (Pa · sec) | 28.76 |
| In-situ thermal resistance, Si/Al (mm² · K/W) | 18.45 |
| Bond line thickness, (mils) | 1.71 |

### EXAMPLE 18

Planetary mixer was used.

| Component - Type | Grams |
|---|---|
| Vinyl polymer - M^{vi}D₁₅₀M^{vi} | 97.29 |
| Silver filler - Ames Goldsmith LCP-1-19SFS | 809.6 |
| Adhesion promoter - Bis(trimethoxysilylpropyl fumarate) | 1.095 |
| Catalyst - 1.75% solution of Pt(0) in D^{vi}₄ | 0.059 |
| Additive - 5% Pt on alumina | 0.389 |
| Inhibitor - General Electric SL6040-D1 | 1.646 |
| Silicone hydride - MD₅₀D^{H}₅₀M | 9.90 |

| Property (units) | Measurement |
|---|---|
| Viscosity (Pa · sec) | 10.03 |
| In-situ thermal resistance, Si/Al (mm² · K/W) | 29.83 |
| Bond line thickness, (mils) | 2.55 |

### EXAMPLE 19

Planetary mixer was used.

| Component - Type | Grams |
|---|---|
| Vinyl polymer - M^{vi}D₄₂₀M^{vi} | 95.87 |
| Silver filler - Ames Goldsmith AG4300 | 809.6 |
| Adhesion promoter - Bis(trimethoxysilylpropyl fumarate) | 1.094 |
| Catalyst - 1.75% solution of Pt(0) in D^{vi}₄ | 1.172 |
| Inhibitor - General Electric SL6040-D1 | 1.652 |
| Silicone hydride - MD₅₀D^{H}₅₀M | 10.60 |

| Property (units) | Measurement |
|---|---|
| Viscosity (Pa · sec) | 37.91 |
| In-situ thermal resistance, Si/Al (mm² · K/W) | 31.85 |
| Bond line thickness, (mils) | 2.92 |

### EXAMPLE 20

Hauschild mixer was used.

| Component - Type | Grams |
|---|---|
| Vinyl polymer - M^{vi}D₁₅₀M^{vi} | 3.93 |
| Silver filler - Ames Goldsmith AEP-2 | 35.20 |
| Adhesion promoter - Bis(trimethoxysilylpropyl fumarate) | 0.048 |
| Catalyst - 1.75% solution of Pt(0) in D^{vi}₄ | 0.051 |
| Inhibitor - General Electric SL6040-D1 | 0.072 |
| Silicone hydride - MD₅₀D^{H}₅₀M | 0.700 |

| Property (units) | Measurement |
|---|---|
| Viscosity (Pa · sec) | 4.15 |
| In-situ thermal resistance, Si/Al (mm² · K/W) | 67.27 |
| Bond line thickness, (mils) | 1.56 |

### EXAMPLE 21

Hauschild mixer was used.

| Component - Type | Grams |
|---|---|
| Vinyl polymer - M^{vi}D₂₅₀M^{vi} | 3.99 |
| Silver filler - Ames Goldsmith AEP-2 | 35.21 |
| Adhesion promoter - Bis(trimethoxysilylpropyl fumarate) | 0.048 |
| Catalyst - 1.75% solution of Pt(0) in D^{vi}₄ | 0.051 |
| Inhibitor - General Electric SL6040-D1 | 0.072 |
| Silicone hydride - MD₅₀D^{H}₅₀M | 0.634 |

| Property (units) | Measurement |
|---|---|
| Viscosity (Pa · sec) | 9.24 |
| In-situ thermal resistance, Si/Al (mm² · K/W) | 35.11 |
| Bond line thickness, (mils) | 1.77 |

### EXAMPLE 22

Hauschild mixer was used.

| Component - Type | Grams |
|---|---|
| Vinyl polymer - M^{vi}D₄₂₀M^{vi} | 4.17 |
| Silver filler - Ames Goldsmith AEP-2 | 35.20 |
| Adhesion promoter - Bis(trimethoxysilylpropyl fumarate) | 0.048 |
| Catalyst - 1.75% solution of Pt(0) in D^{vi}₄ | 0.051 |
| Inhibitor - General Electric SL6040-D1 | 0.072 |
| Silicone hydride - MD₅₀D^{H}₅₀M | 0.461 |

| Property (units) | Measurement |
|---|---|
| Viscosity (Pa · sec) | 32.52 |
| In-situ thermal resistance, Si/Al (mm² · K/W) | 58.18 |
| Bond line thickness, (mils) | 1.79 |

### EXAMPLE 23

Planetary mixer was used.

| Component - Type | Grams |
|---|---|
| Vinyl polymer A - M^{vi}D₁₅₀M^{vi} | 46.08 |
| Vinyl polymer B - M^{vi}D₂₂₀D^{diPh}₁₈M^{vi} | 46.08 |
| Silver filler - Ames Goldsmith AG4300 | 809.68 |
| Adhesion promoter - Bis(trimethoxysilylpropyl fumarate) | 1.097 |
| Catalyst - 1.75% solution of Pt(0) in D^{vi}₄ | 1.171 |
| Inhibitor - General Electric SL6040-D1 | 1.650 |
| Silicone hydride - MD₅₀D^{H}₅₀M | 14.24 |

| Property (units) | Measurement |
|---|---|
| Viscosity (Pa · sec) | 19.07 |
| Elongation at break (%) | 34 |
| Youngs modulus (psi) | 10205 |
| In-situ thermal resistance, Si/Al (mm² · K/W) | 31.08 |
| Bond line thickness, (mils) | 1.91 |

### EXAMPLE 24

Planetary mixer was used.

| Component - Type | Grams |
|---|---|
| Vinyl polymer - M^{vi}D²²⁰D^{diPh}₁₈M^{vi} | 94.09 |
| Silver filler - Ames Goldsmith AG4300 | 809.65 |
| Adhesion promoter - Bis(trimethoxysilylpropyl fumarate) | 1.091 |
| Catalyst - 1.75% solution of Pt(0) in D^{vi}₄ | 1.171 |
| Inhibitor - General Electric SL6040-D1 | 1.650 |
| Silicone hydride - MD₅₀D^{H}₅₀M | 12.35 |

| Property (units) | Measurement |
|---|---|
| Viscosity (Pa · sec) | 46.86 |
| In-situ thermal resistance, Si/Al (mm² · K/W) | 28.67 |
| Bond line thickness, (mils) | 2.03 |

### EXAMPLE 25

Planetary mixer was used.

| Component - Type | Grams |
|---|---|
| Vinyl polymer - M^{vi}D₁₅₀M^{vi} | 87.05 |
| Silver filler - Ames Goldsmith AG4300 | 809.63 |
| Non-silver filler - Double-treated fumed silica | 3.72 |
| Adhesion promoter - Bis(trimethoxysilylpropyl fumarate) | 1.094 |
| Catalyst - 1.75% solution of Pt(0) in D^{vi}₄ | 1.169 |
| Inhibitor - General Electric SL6040-D1 | 1.647 |
| Silicone hydride - MD₅₀D^{H}₅₀M | 15.69 |

| Property (units) | Measurement |
|---|---|
| Viscosity (Pa · sec) | 8.26 |
| In-situ thermal resistance, Si/Al (mm² · K/W) | 30.39 |
| Bond line thickness, (mils) | 1.95 |

The foregoing examples are merely illustrative of the invention, serving to illustrate only some of the features of the present invention. The appended claims are intended to claim the invention as broadly as it has been conceived and the examples herein presented are illustrative of selected embodiments from a manifold of all possible embodiments. Accordingly it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Further, where the word “plurality” is used it is intended to mean two or more. Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims. All United States patents referenced herein are herewith and hereby specifically incorporated by reference.

Having described the invention, that which is claimed is:

1. A curable thermally and electrically conductive adhesive composition comprising:
a) an alkenyl bearing siloxane having the formula:
MₐD_{b}D′_{c}T_{d}Qₑ where
M=R¹R²R³SiO_{1/2};
D=R⁴R⁵SiO_{2/2};
D′=R⁶R⁷SiO_{2/2};
T=R⁸SiO_{3/2}; and
Q=SiO_{4/2} with
with each R¹, R², R⁴, R⁵, R⁶ and R⁸ independently selected from the group of C1 to C40 monovalent hydrocarbon radicals and each R³ and R⁷ independently selected from the group of C2 to C40 monovalent alkenyl hydrocarbon radicals, the stoichiometric coefficients a and b are non-zero and positive while the stoichiometric coefficients c, d and e are zero or positive subject to the requirement that a+c is greater than or equal to 2;
b) a hydrido-siloxane having the formula:
M′_{f}D″_{g}D″′ₕT′ᵢQ′ⱼ
where
M′=R⁹R¹⁰R¹¹SiO_{1/2};
D″=R¹²R¹³SiO_{2/2};
D″′=R¹⁴R¹⁵SiO_{2/2};
T′=R¹⁶SiO_{3/2}; and
Q′=SiO_{4/2}
with each R⁹, R¹⁰, R¹², R¹⁴, R⁶ and R¹⁶ independently selected from the group of C1 to C40 monovalent hydrocarbon radicals and each R¹¹ and R¹⁵ is hydrogen, the stoichiometric coefficients f and g are non-zero and positive while the stoichiometric coefficients h, i and j are zero or positive subject to the requirement that f+g is greater than or equal to 2;
c) an electrically and thermally conductive filler;
d) a hydrosilylation catalyst;
e) an adhesion promoter that does not deactivate said hydrosilylation catalyst; and
f) a hydrosilylation catalyst inhibitor.

2. The composition of claim 1 wherein the electrically and thermally conductive filler having at least an outer surface of a metal is selected from the group consisting of silver, gold, platinum, palladium, ruthenium, osmium, rhodium, iridium and alloys thereof.

3. The composition of claim 2 further comprising a thermally conductive filler selected from the group consisting of aluminum oxide, aluminum nitride, boron nitride, diamond, magnesium oxide, zinc oxide, silicon oxide, and zirconium oxide.

4. The composition of claim 3 wherein the adhesion promoter is selected from the group consisting of aminoalkyl silanes, methacryloxy silanes, acryloxy silanes, isocyanurates, allyl isocyanurates, fumarates, succinates, maleates, alkoxy silanes, epoxy silanes, allylic alcohols, metal alkoxides, mercaptoalkyl silanes, allyl glycidyl ethers, silyl phosphates, bis(3-trimethoxysilylpropyl) fumarate and combinations thereof.

5. The composition of claim 5 wherein the hydrosilylation catalyst inhibitor is selected from the group consisting of maleates, alkynes, phosphites, alkynols, fumarates, succinates, cyanurates, isocyanurates, alkynylsilanes, vinyl-containing siloxanes and combinations thereof. Inhibitors such as esters of maleic acid (e.g. diallylmaleate, dimethylmaleate), acetylenic alcohols (e.g., 3,5 dimethyl-1-hexyn-3-ol and 2 methyl-3-butyn-2-ol), amines, and tetravinyltetramethylcyclotetrasiloxane and mixtures thereof.

6. A cured thermally and electrically conductive adhesive composition comprising the reaction product of:
a) an alkenyl bearing siloxane having the formula:
MₐD_{b}D′_{c}T_{d}Qₑ
where
M=R¹R²R³SiO_{1/2};
D=R⁴R⁵SiO_{2/2};
D′=R⁶R⁷SiO_{2/2};
T=R⁸SiO_{3/2}; and
Q=SiO_{4/2} with
with each R¹, R², R⁴, R⁵, R⁶ and R⁸ independently selected from the group of C1 to C40 monovalent hydrocarbon radicals and each R³ and R⁷ independently selected from the group of C2 to C40 monovalent alkenyl hydrocarbon radicals, the stoichiometric coefficients a and b are non-zero and positive while the stoichiometric coefficients c, d and e are zero or positive subject to the requirement that a+c is greater than or equal to 2;
b) a hydrido-siloxane having the formula:
M′_{f}D″_{g}D″′ₕT′ᵢQ′ⱼ
where
M′=R⁹R¹⁰R¹¹SiO_{1/2};
D″=R¹²R¹³SiO_{2/2};
D″′=R¹⁴R¹⁵SiO_{2/2};
T′=R¹⁶SiO_{3/2}; and
Q′=SiO_{4/2}
with each R⁹, R¹⁰, R¹², R¹⁴, R⁶ and R¹⁶ independently selected from the group of C1 to C40 monovalent hydrocarbon radicals and each R¹¹ and R¹⁵ is hydrogen, the stoichiometric coefficients f and g are non-zero and positive while the stoichiometric coefficients h, i and j are zero or positive subject to the requirement that f+g is greater than or equal to 2;
c) an electrically and thermally conductive filler;
d) a hydrosilylation catalyst;
e) an adhesion promoter that does not deactivate said hydrosilylation catalyst; and
f) a hydrosilylation catalyst inhibitor.

7. The composition of claim 6 wherein the electrically conductive filler having at least an outer surface of a metal selected from the group consisting of silver, gold, platinum, palladium, ruthenium, osmium, rhodium, iridium and alloys thereof.

8. The composition of claim 7 further comprising a thermally conductive filler selected from the group consisting of aluminum oxide, aluminum nitride, boron nitride, diamond, magnesium oxide, zinc oxide, and zirconium oxide.

9. The composition of claim 8 wherein the adhesion promoter is selected from the group consisting of aminoalkyl silanes, methacryloxy silanes, acryloxy silanes, isocyanurates, allyl isocyanurates, fumarates, succinates, maleates, alkoxy silanes, epoxy silanes, allylic alcohols, metal alkoxides, mercaptoalkyl silanes, allyl glycidyl ethers, silyl phosphates, bis(3-trimethoxysilylpropyl) fumarate and combinations thereof.

10. The composition of claim 9 wherein the hydrosilylation catalyst inhibitor is selected from the group consisting of maleates, alkynes, phosphites, alkynols, fumarates, succinates, cyanurates, isocyanurates, alkynylsilanes, vinyl-containing siloxanes and combinations thereof. Inhibitors such as esters of maleic acid (e.g. diallylmaleate, dimethylmaleate), acetylenic alcohols (e.g., 3,5 dimethyl-1-hexyn-3-ol and 2 methyl-3-butyn-2-ol), amines, and tetravinyltetramethylcyclotetrasiloxane and mixtures thereof.

11. An electronic device assembled from a plurality of components comprising the composition of claim 1.

12. An electronic device assembled from a plurality of components comprising the composition of claim 6.
